(19) United States
(12) Patent Application Publication
(10) Pub. No.: US 2022/0212315 A1
(43) Pub. Date: Jul. 7, 2022

(54) Modular Single-Handed Clamping Apparatus and Method

(71) Applicants: Emmet Thomas Costen, CHARLOTTESVILLE, VA (US); Michael Kittridge Costen, Milford, CT (US)

(72) Inventors: Emmet Thomas Costen, CHARLOTTESVILLE, VA (US); Michael Kittridge Costen, Milford, CT (US)

(73) Assignee: DIMIDE, INC., MILFORD, CT (US)

(21) Appl. No.: 17/248,050

(22) Filed: Jan. 6, 2021

(51) Int. Cl. B25B 5/10

(52) U.S. Cl. CPC B25B 5/101; B25B 5/103

(57) ABSTRACT

Disclosed herein is a clamping apparatus that is designed to be modular to facilitate use in numerous applications. In particular the modularity is fast and easy to manually perform without the need of tools. This modularity is facilitated by elongated elements which are configured to resist undesired removal, but facilitate desired removal. The modularity of the clamping apparatus is facilitated with the use of many interchangeable shoes and a variety of structural jaws. The clamping apparatus may be operated with the option of using a power tool, hand tool, or handle elongated element and may be configured to facilitate single hand operation.

### RELATED MATTERS

This application is a nonprovisional patent application which claims priority to U.S. Provisional Application No. 62/266,822, filed on Dec. 14, 2015, entitled “Clamping Apparatus and Method,” and U.S. Provisional Application No. 62/289,487, filed on Feb. 1, 2016, entitled “Clamping Apparatus and Method,” and U.S. Provisional Application No. 62/957,377, filed Jan. 6, 2020, entitled “Modular Single-Handed Clamping Apparatus and Method,” the disclosure of which being herein incorporated by reference, and that builds upon technology contained in utility U.S. Pat. No. 10,307,893 B2 granted Jun. 4, 2019, entitled “Clamping Apparatus and Method,” which is hereby incorporated by reference in its entirety.

### FIELD OF TECHNOLOGY

The subject matter disclosed herein relates generally to clamps. More particularly, the subject matter relates to a modular, and/or power tool compatible, and/or single hand operated, and/or surface mounted clamp.

### BACKGROUND

Existing individual clamps are limited in applications. These clamps have fixed clamping surfaces and structures that limit their ability to be used for different applications which require different clamping surfaces, features, and/or structure. This causes many projects to require the use of a variety of types of clamps. Existing multi-purpose clamps that allow for additional clamp surfaces or features to be used do so in a way that limits how much the clamp may be modified to fit additional applications.

In addition, existing clamps which offer power tool compatibility do so in a manner that requires two hand operation with one hand holding the clamp and the other holding the power tool. Existing locking clamps which allow for single hand operation are limited in clamp force by the operators grip strength.

In addition, existing surface mounted clamps are limited to manual screw, or toggle mechanism which are either slow or offer little clamping force. Alternative surface mounted clamps including hydraulic and pneumatic clamps have high price points, long setup times, cumbersome equipment, and require significant maintenance.

### BRIEF DESCRIPTION

According to one embodiment, a clamping apparatus comprises: an upper jaw structure having a hinge end, clamp end and a nut located between; a lower jaw structure having a hinge end, a clamp end and nut located between; an elongated element threadably engaged with the nuts of the upper and lower jaw structure whereas, rotation of the elongated element in the first direction causes the clamp ends of the upper and lower jaw structures to move closer to one another whereas, the elongated element may be oriented parallel to the direction of the clamp end actuation of the upper and lower jaw structures whereas, the elongated element includes ends having various shapes; one end may be configured to join with a safety stop and one end configured with a hexagonal shape to receive, and depending upon the tool, be retained by the tool while facilitating release when desirable; the tool being used to rotate the threadably engaged elongated element; the safety stop being configured to prevent the gap between the hinge and the threadably engaged elongated element from closing beyond a predetermined amount; the tool selected from the group which may consist of hand tools and power tools including for example a wrench, ratchet, breaker bar, an impact wrench, an impact driver, and a drill; the safety stop may be configured to receive an elongated element configured to resist undesired removal but facilitate desired removal without the necessity of an additional tool which facilitates the rotation of the threadably engaged elongated element; the clamp ends of the upper and lower jaw structures are configured with an elongated element configured to resist undesired removal but facilitate desired removal without the necessity of an additional tool which facilitate attaching and interchanging shoes; the shoes may for example be configured to facilitate any of the following: clamping round surfaces, increasing clearance, transferring electrical current, mounting to a surface, delivering uniform clamping pressure over an extended length, or conducting heat away from clamped material; the jaw structures may be configured to receive additional elongated elements which may provide a means of attaching accessories to facilitate additional capabilities; any of the jaw structure elongated elements utilized in the clamping apparatus may be configured to facilitate resisting undesired removal while permitting desired removal without the necessity of an additional tool; a hinge located at the hinge ends of the upper and lower jaw structure, the hinge providing for rotation of the upper jaw structure with respect to the lower jaw structure; the hinge connection consisting of an elongated element configured to resist undesired removal but facilitate desired removal without the necessity of an additional tool; the hinge may facilitate removing and interchanging the upper jaw structure as well as attaching clamping accessories; additional upper jaw structures may for example be configured to facilitate increasing clearance; the upper jaw structure may also be configured with alternative lower jaw structure profiles and threadably engaged elongated elements; additional lower jaw structures for example may be configured to facilitate alternative clamping apparatus orientations or mounting to a surface; One alternative lower jaw structure differs in that the nut and hinge have swapped their described positions. This jaw structure has a clamp end, nut end and hinge located between; in this configuration the elongated element threadably engaged with the nuts of the upper and alternate lower jaw structures may for example be oriented perpendicular to the direction of actuation of the clamp end of the upper and lower jaw structures; wherein rotation in the first direction of the threadably engaged elongated element still causes the clamp ends of the upper and alternate lower jaw structure to move closer together; A second alternative lower jaw structure differs in that it has substituted a surface mount for its clamp end. This jaw structure has a surface mount end, nut end and hinge located between; in this configuration the loads of the clamp end of the upper jaw structure push on the mounted surface and are transferred through the surface to the mount end of the second alternate lower jaw structure; rotation in the first direction of the threadably engaged elongated element causes the clamp end to move toward the mount surface; all of the previously mentioned clamping apparatus configurations may facilitate single hand power tool operation with an accessory that prevents the free rotation of the clamping apparatus relative to a power tool which may be rotating the threadably engaged elongated element; this capability facilitates single hand operation with a retained power tool.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a side view of a clamping apparatus in an open state in accordance with one embodiment.

FIG. 2 depicts a side view of the clamping apparatus of FIG. 1 in a closed state in accordance to one embodiment.

FIG. 3 depicts a cross sectional view of the clamping apparatus of FIG. 1 in an open state in accordance to one embodiment.

FIG. 4 depicts an isometric view of the clamping apparatus of FIG. 1 in an open state with the upper and lower clamp shoes, upper and lower shoe elongated elements, hinge element, and elongated T-handle element removed in accordance with one embodiment.

FIG. 5 depicts an isometric view of the clamping apparatus of FIG. 1 in an open state operated with a hand tool and the elongated handle element bar in accordance with one embodiment.

FIG. 6 depicts an isometric view of the clamping apparatus of FIG. 1 in an open state being operated with a power tool while the elongated handle element is removed in accordance with one embodiment.

FIG. 7 depicts a side view of the clamping apparatus of FIG. 1 in an open state with a potential clamp shoe configured to facilitate the clamping of rounded surfaces. The shoe has been installed in an orientation that accommodates larger diameter rounded surfaces in accordance with one embodiment.

FIG. 8 depicts a side view of the clamping apparatus of FIG. 1 in an open state with the potential clamp shoe of FIG. 7 installed in an orientation that accommodates clamping smaller diameter rounded surfaces in accordance with one embodiment.

FIG. 9 depicts an isometric view of the clamping apparatus of FIG. 1 in an open state with another potential clamp shoe design which may be configured to facilitate increased clearance in accordance with one embodiment.

FIG. 10 depicts an isometric view of the clamping apparatus of FIG. 1 in an open state with the potential clamp shoe design from FIG. 7 and another potential clamp shoe design which may be configured to facilitate the transfer of electric current to the clamped material in accordance with one embodiment.

FIG. 11 depicts an isometric view of the clamping apparatus of FIG. 1 in an open state with another potential clamp shoe design which may be configured to facilitate the transfer of substantial electric current to the clamped material in accordance with one embodiment.

FIG. 12 depicts an isometric view of the clamping apparatus of FIG. 1 in an open state with another potential clamp shoe design which may be configured to facilitate mounting the clamp to a surface in accordance with one embodiment.

FIG. 13 depicts a side view of a clamping apparatus in an open state consisting of two clamping apparatuses from FIG. 1 with another potential clamp shoe design which may be configured to facilitate connecting two clamping apparatuses and applying clamping force over an extended length in accordance with one embodiment.

FIG. 14 depicts a side view of a clamping apparatus in an open state consisting of two clamping apparatuses from FIG. 1 with another potential clamp shoe design which may be configured to facilitate connecting two clamping apparatuses and conducting heat away from the clamped material over an extended length in accordance with one embodiment.

FIG. 15 depicts a side view of the clamping apparatus of FIG. 1 in an open state with a potential clamp accessory design which may be configured to facilitate another clamping pad which actuates perpendicular to the direction of actuation of the upper and lower clamping jaws in accordance with one embodiment.

FIG. 16 depicts a side view of a clamping apparatus in an open state consisting of two clamping apparatuses from FIG. 16 which are connected by two potential clamp shoe designs from FIG. 15 which may be configured to facilitate applying clamping force from four directions in accordance with one embodiment.

FIG. 17 depicts an isometric view of the clamping apparatus of FIG. 1 with another potential clamp accessory design which may be configured to facilitate increasing the clamping reach length in accordance with one embodiment.

FIG. 18 depicts an isometric view of a clamping apparatus in an open state consisting of two clamping apparatuses from FIG. 1 which are connected by another potential accessory which may be configured to facilitate aligning two clamped elements at specific angles in relation to each other in accordance with one embodiment.

FIG. 19 depicts an isometric view of the clamping apparatus of FIG. 1 with another potential upper clamp profile which may be configured to facilitate increasing clearance in accordance with one embodiment.

FIG. 20 depicts an isometric view of the clamping apparatus of FIG. 1 with another potential lower clamp profile and core elongated drive which may be configured to facilitate use of the clamp in another orientation with the elongated element perpendicular to the direction of actuation of the upper and lower clamp jaws in accordance with one embodiment.

FIG. 21 depicts an isometric view of the clamping apparatus of FIG. 1 with another potential lower clamp profile which may be configured to facilitate mounting the clamping apparatus onto a surface in accordance with one embodiment.

FIG. 22 depicts a hidden part isometric view of the clamping apparatus of FIG. 1 in an open state with another potential clamp accessory in a detached state which may be configured to facilitate single-handed use of the clamp with a power tool in accordance with one embodiment.

FIG. 23 depicts an isometric view of the clamping apparatus of FIG. 22 in an open and attached state in accordance with one embodiment.

FIG. 24 depicts an isometric view of the clamping apparatus of FIG. 22 in a closed and attached state in accordance with one embodiment.

FIG. 25 depicts a side view of the clamping apparatus of FIG. 1 in an open state with another potential clamp accessory which may be configured to facilitate single-handed use of the clamp with a power tool in accordance with one embodiment.

FIG. 26 depicts a cross sectional side view of the clamping apparatus of FIG. 25 in an open state in accordance with one embodiment.

### SUMMARY

Thus, a clamping apparatus which offers increased modularity and single-handed power tool operation would be well received in the art.

### DETAILED DESCRIPTION

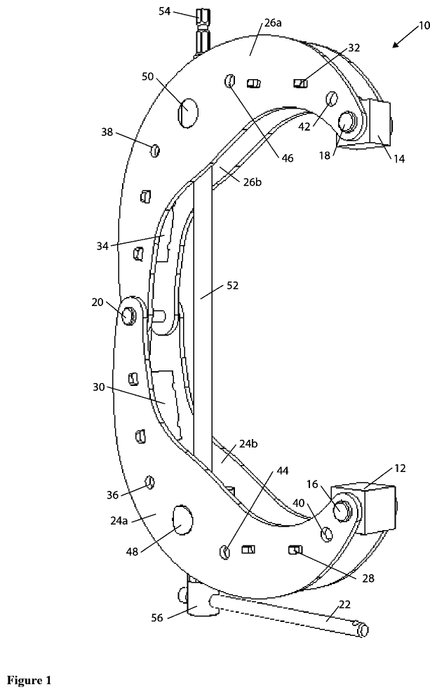

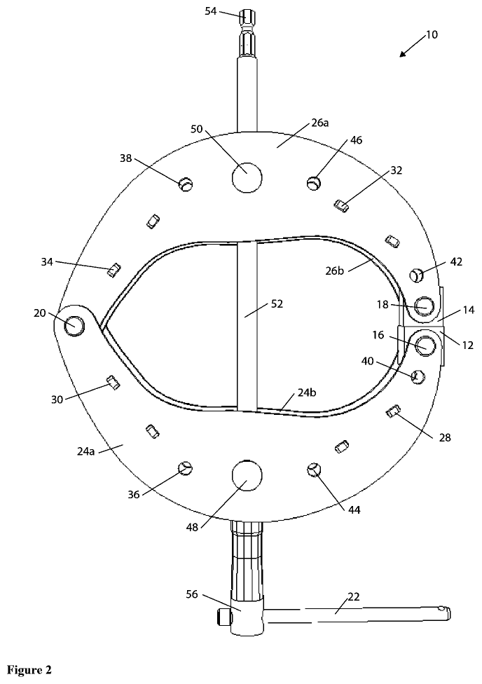

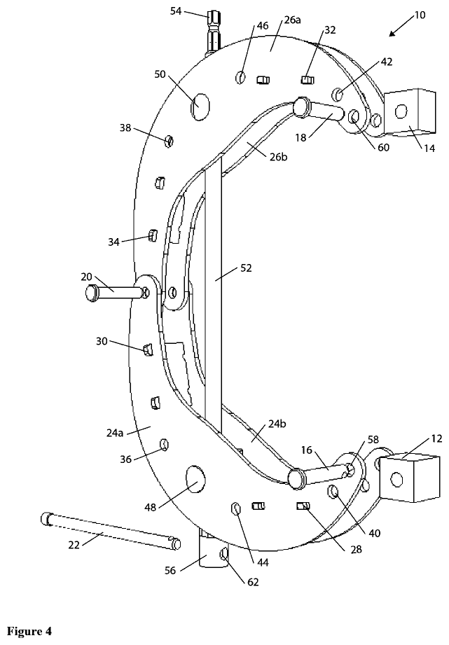

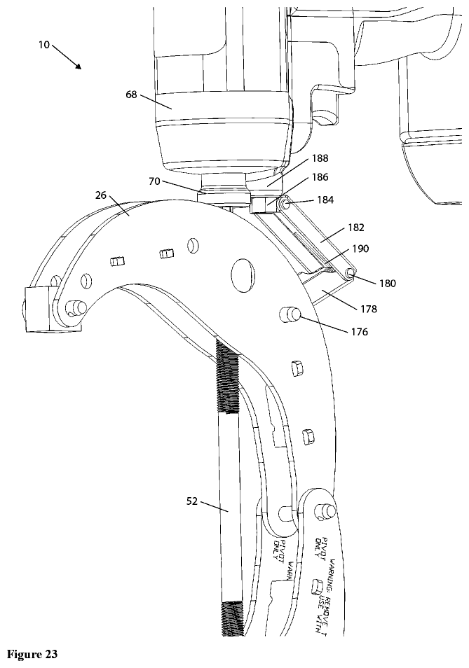

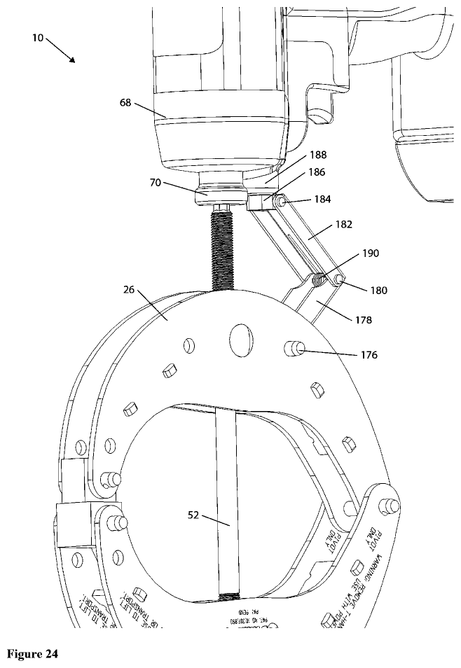

A first embodiment of a clamping apparatus 10 is shown in FIGS. 1-27. Referring now to FIGS. 1-4 showing one configuration of clamping apparatus 10. Clamping apparatus 10 having a lower jaw structure 24 and upper jaw structure 26. The lower jaw structure and upper jaw structure 24, 26 are attached in a pivotable manner at a hinge 20 located at the first end of the upper jaw and lower jaw 24, 26. The hinge connection 20 may be cylindrical which facilitates the rotation of the lower jaw structure 24 in respect to the upper jaw structure 26. The hinge 20 may be configured to resist undesired removal but facilitate desired removal without the necessity of additional tools from upper and lower jaw 24, 26, as shown in FIG. 4. The lower jaw structure 24 has a lower jaw elongated element 16 which may facilitate attaching a lower clamp jaw 12. The lower jaw elongated element 16 may be configured to resist undesired removal but facilitate desired removal without the necessity of additional tools from the lower jaw structure 24 to facilitate removing the lower clamp shoe 12, as shown in FIG. 4, and replacing it with another potential lower clamp shoe design. The lower jaw structure 24 consists of two parallel plate elements 24a, 24b. These plate elements 24a, 24b in the lower jaw structure 24 are connected by perpendicular plate elements 28, 30. Between plate elements 28, 30 is a lower nut 48 which may be attached to the lower jaw structure 24 in way which may facilitate rotating in relation to the lower jaw structure 24. The lower nut 48 may be threadably attached to elongated element 52. The upper jaw structure 26 has an upper jaw elongated element 18 which may facilitate attaching an upper clamp shoe 14. The upper jaw elongated element 18 may be configured to resist undesired removal but facilitate desired removal without the necessity of additional tools from the upper jaw structure 26 to facilitate removing the upper clamp jaw 14, as shown in FIG. 4, and replacing it with another potential upper clamp shoe design. The upper jaw structure 26 consists of two parallel plate elements 26a, 26b. These plate elements in the upper structure jaw structure 26a, 26b are connected by perpendicular plate elements 32, 34. Between plate elements 32, 34 is an upper nut 50 which may be attached to the upper jaw structure 26 in way which may facilitate rotating in relation to the upper jaw structure 26. The upper nut 50 may be threadably attached to the threaded elongated element 52. The lower jaw structure 24 may include additional holes 36, 40, 44 which may facilitate attaching additional potential clamping apparatus accessories and jaws. Hole 36 may be located between lower nut 48 and plate element 30. Hole 40 may be located between plate element 28 and lower jaw elongated element 16. Hole 44 may be located between lower nut 48 and plate element 28. The upper jaw structure 26 may include additional holes 38, 42, 46 which may facilitate attaching additional potential clamping apparatus accessories and jaws. Hole 38 may be located between upper nut 50 and plate element 34. Hole 40 may be located between plate element 32 and upper jaw elongated element 18. Hole 46 may be located between upper nut 50 and plate element 32.

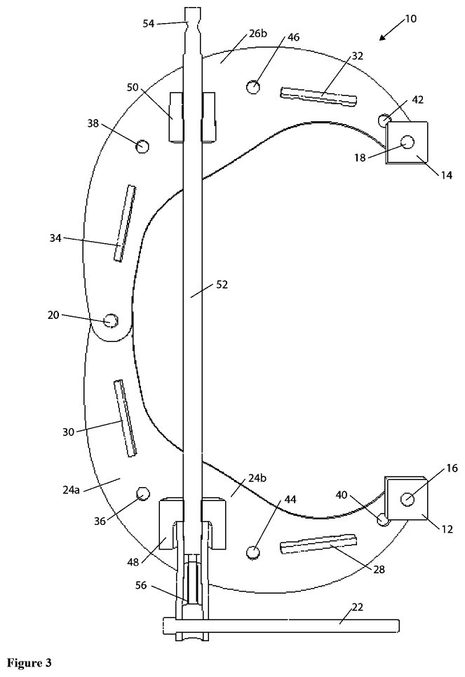

As shown in FIG. 3, the clamping apparatus 10 may include an elongated element 52 configured as a turnbuckle screw. As elongated element 52 is rotated in one direction, the distance between lower clamp jaw 12 and upper clamp jaw 14 may reduce. The lower nut and upper nut 48, 50 may each include an elongated structure having a widened portion closer to the outer edges of the lower jaw structure and upper jaw structure 24, 26. The lower nut and upper nut 48, 50 may include threads closer to the inner edges of the lower jaw structure and upper jaw structure 24, 26. Within the widened portion of the lower nut and upper nut 48, 50 there may be an opening which may be configured as a bore, hollow, gap, void, or the like. The opening may be configured to receive a safety stop 56. The safety stop 56 may be attached to the elongated element 52 and create a shoulder of greater diameter. The safety stop 56 may operate in conjunction with the opening in the lower nut 48 to facilitate preventing the hinge 20 from approaching the elongated element 52 beyond a predetermined amount. This distance may be greater than one inch, for example, to prevent the clamping apparatus 10 from applying pressure to the person or thing holding the clamping apparatus 10 while the distance between the lower clamp jaw 12 and upper clamp jaw 14 is increasing. The safety stop 56 may have a hole configured to receive elongated element 22. Elongated element 22 may be configured to facilitate the rotation of elongated element 52. The elongated element 22 may also be configured to resist undesired removal but facilitate desired removal without the necessity of additional tools.

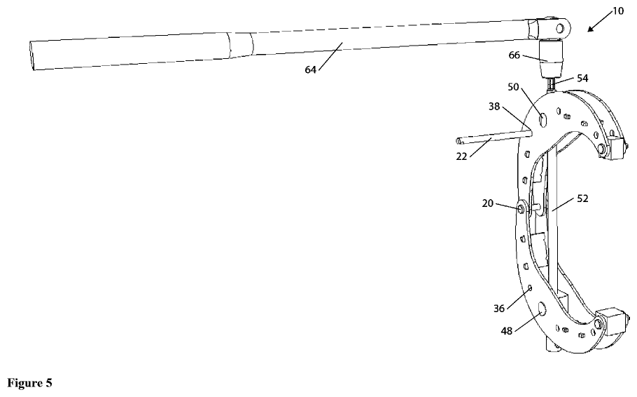

Referring now to FIG. 5 showing another configuration of clamping apparatus 10. In operation the clamping apparatus 10 may accept a socket 66 on elongated element 54 to facilitate the use of hand tool 64 to rotate elongated element 52. The elongated element 22 may be configured to react torque from hand tool 64. The elongated element 22 shown in FIG. 1 being inserted into hole 62 in the safety stop 56 may also be inserted into holes 38, 36, 46, 44, 42, or 40.

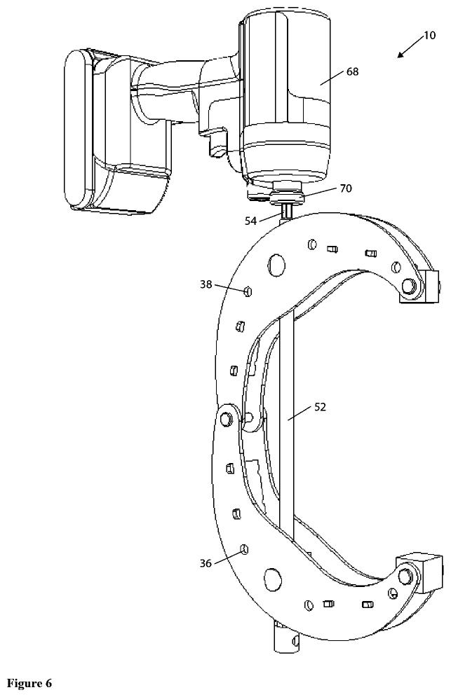

Referring now to FIG. 6 showing another configuration of clamping apparatus 10. In operation the clamping apparatus 10 elongated element 54 may be inserted into power tool chuck 70 to facilitate the use of power tool 68 to rotate core elongated element 52. The circumferential groove around the external radius of elongated element 54 may facilitate for elongated element 54 to be retained when desired and detached when desired by power tool chuck 70.

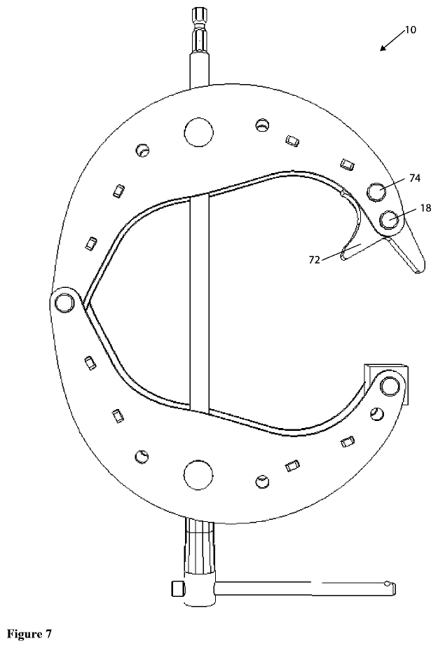

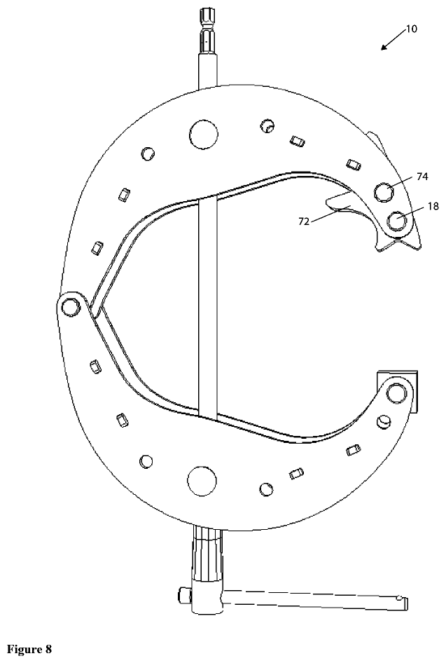

Referring now to FIGS. 7-8 showing another configuration of clamping apparatus 10. Clamping apparatus 10 may be configured with another potential shoe design 72 which may be configured to facilitate the clamping of rounded surfaces. Clamp jaw elongated element 74 may be configured to facilitate preventing potential shoe design 72 from rotating in relation to clamp jaw elongated element 18. Potential shoe design 72 may be configured as shown in FIG. 7 to facilitate the clamping of rounded surfaces with larger diameters. Potential shoe design 72 may also be configured as shown in FIG. 8 to facilitate the clamping of rounded surfaces with smaller diameters. Clamp jaw elongated elements 18, 74 may be configured to resist undesired removal while facilitating desired removal to facilitate the interchanging of clamp jaws or changing the configuration of potential clamp jaw 72.

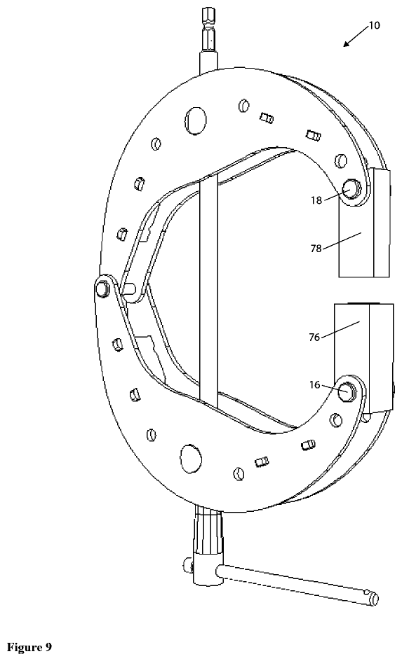

Referring now to FIG. 9 showing another configuration of clamping apparatus 10. Clamping apparatus 10 may be configured with potential shoe designs 76, 78 which consist of elongated elements which may be configured to facilitate increasing clearance.

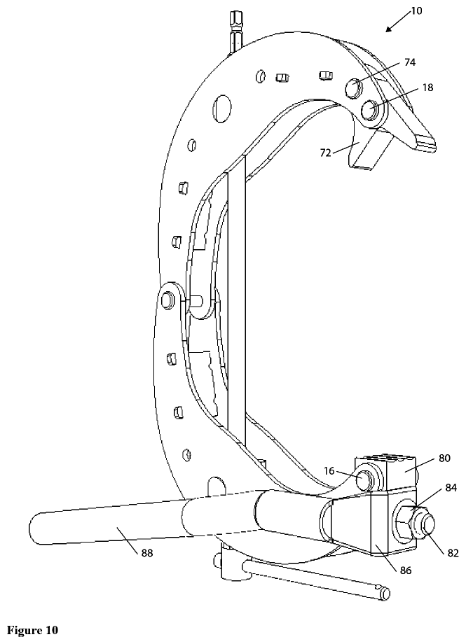

Referring now to FIG. 10 showing another configuration of clamping apparatus 10. Clamping apparatus 10 may be configured with another potential shoe design 80 which may facilitate the transfer of electric current to a clamped material which for example may be used for welding or grounding applications. Elongated element 82 may be used in conjunction with element 84 to force the contact of electrical contact 86 to potential shoe design 80. Electrical contact 86 may be configured to be connected to wire 88 to facilitate the transfer of electric current between wire 88 and potential shoe design 80. Potential shoe design 80 may be configured with potential shoe design 72 to facilitate the transfer of electric current to rounded surfaces. Potential shoe design 80 may also be configured with potential shoe design 12 which is shown in FIG. 1 to facilitate the transfer of electric current to flat surfaces.

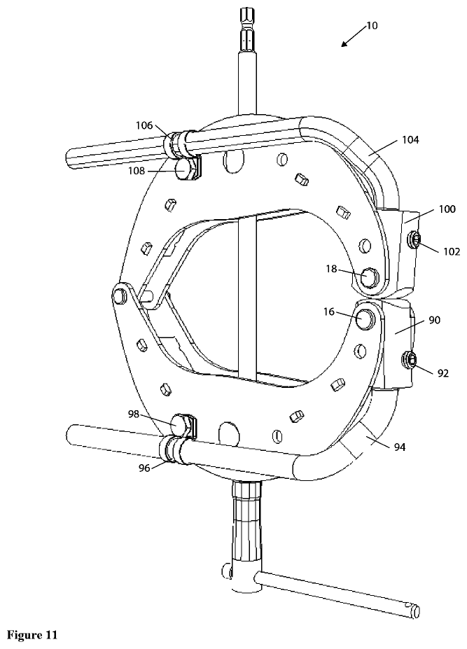

Referring now to FIG. 11 showing another configuration of clamping apparatus 10. Clamping apparatus 10 may be configured with potential shoe designs 90, 100 which may facilitate the transfer of substantial electric current to a clamped material which for example may be used for welding or grounding applications. Elongated elements 92, 102 may be configured to secure and enforce a contact to facilitate the transfer of electric current between wires 94, 104 and potential shoe designs 90, 100. Wires 94, 104 may be configured to be guided to the back of the clamp by clips 96, 106 which may be attached to holes 36, 38 using elongated elements 98, 108.

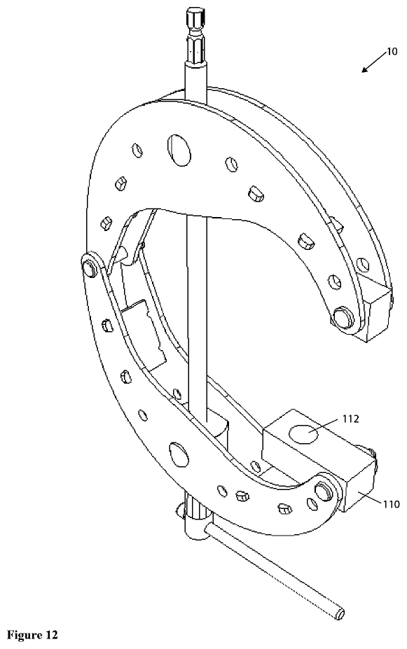

Referring now to FIG. 12 showing another configuration of clamping apparatus 10. Clamping apparatus 10 may be configured with another potential lower shoe design 110. Potential lower shoe design 110 may consist of an elongated flat profile with a hole 112 which may be used for example to secure the clamp to the underside of a surface. One method for mounting the clamping apparatus 10 may be to use an elongated element in combination with hole 112. Another example of a method of mounting the clamping apparatus may be to weld or use adhesive to attach clamp shoe 110 to a surface.

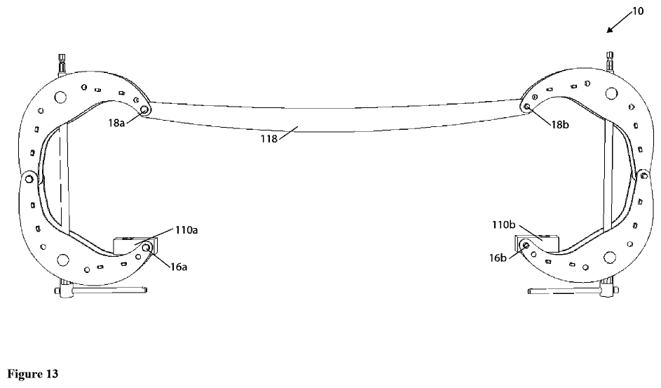

Referring now to FIG. 13 showing the use of two clamping apparatus 10 in another configuration. Two mirroring clamping apparatus 10 may be configured with another potential upper shoe design 118. Potential upper shoe design 118 may be configured to attach to the upper clamp shoe elongated elements of 18a, 18b of two mirroring clamping apparatus 10 at opposite ends of the potential upper shoe design 118. Upper shoe 118 may be configured to facilitate the application of clamping pressure over the length of upper shoe 118 between the two upper elongated elements 18a, 18b.

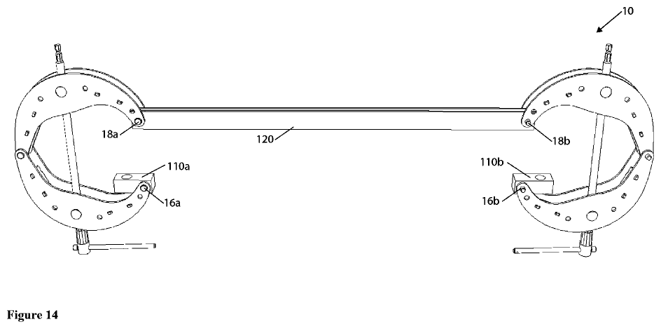

Referring now to FIG. 14 showing the use of two clamping apparatus 10 which is similar to the configuration in FIG. 13. Two mirroring clamping apparatus 10 may be configured with another potential upper shoe design 120. Upper shoe design 120 may be configured to attach to the upper clamp shoe elongated elements 18a, 18b of two mirroring clamping apparatus 10 18a, 18b at opposite ends of the potential upper shoe design 120. Potential upper shoe design 120 may be configured to facilitate the conduction of heat away from the clamped material to the potential upper shoe design 120. Potential upper shoe design 120 may use a thermally conductive material such as aluminum or brass and make contact with the clamped material using a flat surface. Potential upper shoe design 120 may be configured with parallel fins that extend above the flat surface which facilitate the dissipation of heat away from the clamped material.

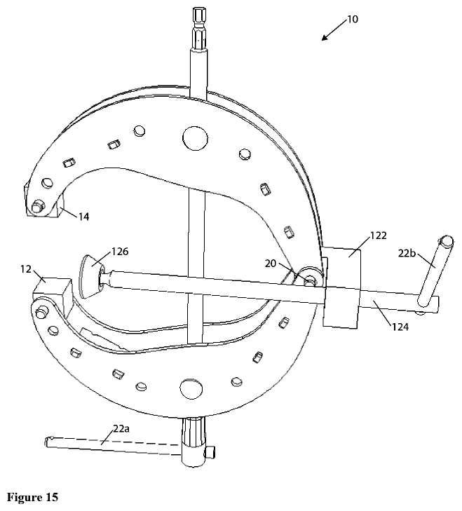

Referring now to FIG. 15 showing another configuration of clamping apparatus 10. Clamping apparatus 10 may be configured with clamping accessory 122 attached to hinge 20. Clamp accessory 122 may threadably attached to elongated element 124 to facilitate linear actuation in a direction perpendicular or close to perpendicular to the direction of actuation of the lower and upper clamp shoes 12, 14. Clamp pad 126 may be configured with elongated element 124 to facilitate the use of an additional clamping contact element. Elongated element 22b may be configured to facilitate the rotation and linear actuation of elongated element 124.

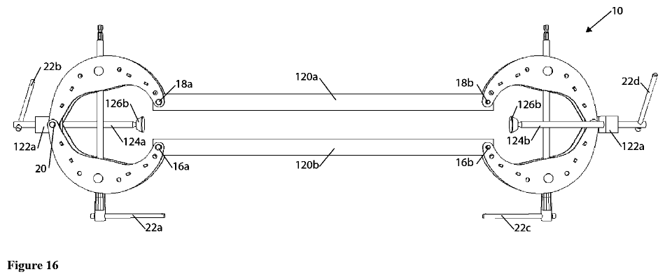

Referring now to FIG. 16 showing the use of two clamping apparatus 10 in another configuration which incorporates two of the potential clamping apparatus shoe designs 120a, 120b from FIG. 15 and two of the clamping accessory configurations incorporating the potential clamping accessory designs 122, 124, 126 from FIG. 16. The potential clamp shoe design 120a, 120b and clamp pads 126a, 126b may be configured to facilitate applying clamping force on four sides.

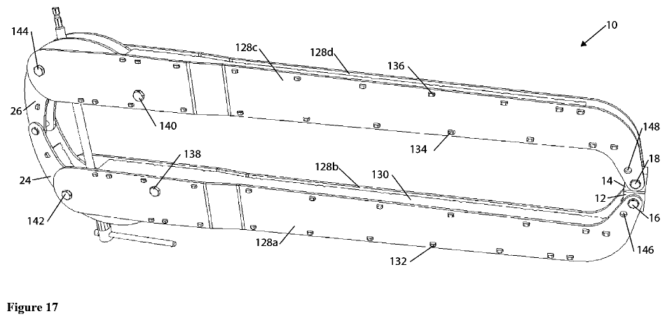

Referring now to FIG. 17 showing another configuration of clamping apparatus 10. Clamping apparatus 10 may be configured with another potential lower clamping accessory design which consists of two parallel plates 128a, 128b which may be formed such that they incorporate a bent portion between the elongated element 138 and the potential lower clamp shoe 12 which reduces the distance between the two parallel plates 128a, 128b such that at the location of the potential lower clamp shoe design 12 the distance between the two parallel plates 128a, 128b matches the distance between the two parallel plates 24a, 24b as shown in FIG. 1 to facilitate the use of potential lower clamp shoe design 12 as well as the other potential lower clamp shoe designs. These plate elements 128a, 128b in the lower structure may be connected by perpendicular plate elements 130, 132 to facilitate increasing the torsional resistance for the clamping apparatus lower accessory. Clamping apparatus 10 be configured with another potential upper clamping accessory design which consists of two parallel plates 128c, 128d which may be formed such that they incorporate a bent portion between the elongated element 140 and the potential upper clamp shoe 14 which reduces the distance between the two parallel plates 128a, 128b such that at the location of the potential upper clamp shoe design 14 the distance between the two parallel plates 128c, 128d matches the distance between the two parallel plates 26a, 26b to facilitate the use of potential upper clamp shoe design 14 as well as the other potential upper clamp shoe designs. These plate elements 128c, 128d in the upper accessory may be connected by perpendicular plate elements 134, 136 to facilitate increasing the torsional resistance for the clamping apparatus upper accessory. The potential lower clamping accessory may be connected to lower jaw structure 24 through the use of elongated elements 138 and elongated element 142 using lower jaw structure hole 36 as shown in FIG. 1. The potential upper clamping accessory may be connected to upper jaw structure 26 through the use of elongated elements 140 and elongated element 144 using lower jaw structure hole 38 as shown in FIG. 1. The hole 146 in the clamping apparatus lower accessory may facilitate the use of potential shoe designs 72 as shown in FIGS. 7-8 and other similar potential shoe designs. The hole 148 in the clamping apparatus upper accessory may facilitate the use of potential shoe designs 72 as shown in FIGS. 7-8 and other similar potential shoe designs.

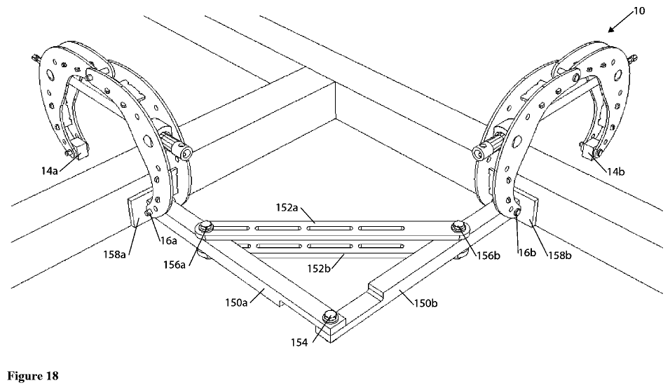

Referring now to FIG. 18 showing another configuration of clamping apparatus 10. Clamping apparatus 10 may be configured with another potential lower shoe design 150. Lower shoe design 150a, 150b may be configured to attach to the lower clamp jaw elongated elements of two clamps 16a, 16b to form another configuration of clamping apparatus 10. The lower shoe designs 150a, 150b may be pivotably connected with hinge 154 to facilitate the rotation of lower shoe designs 150a in relation to lower shoe design 150b. Slotted elongated element 152a, 152b may be configured to facilitate securing the angle between lower shoe designs 150a, 150b using elongated elements 156a, 156b. Clamp pads 158a, 158b may be configured to facilitate the alignment of clamped elongated elements at various angles in relation to each other.

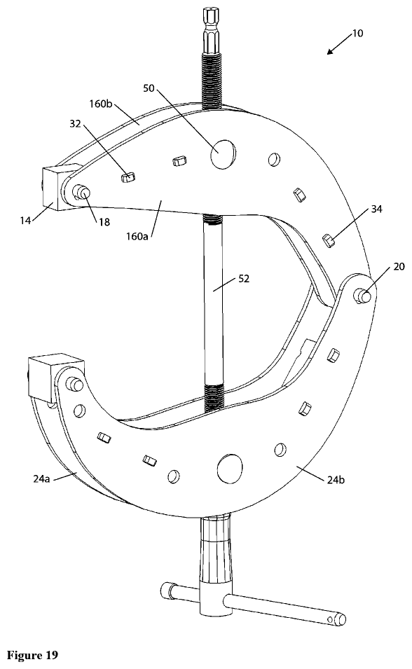

Referring now to FIG. 19 showing another configuration of clamping apparatus 10. Clamping apparatus 10 may be configured with another potential upper jaw structure 160 which facilitates increased clearance for some applications. Potential upper jaw structures 160a, 160b may be connected with perpendicular plate elements 32, 34. The hinge 20 may be removed when desired to facilitate removal of potential upper jaw structure 160 from core elongated element 52.

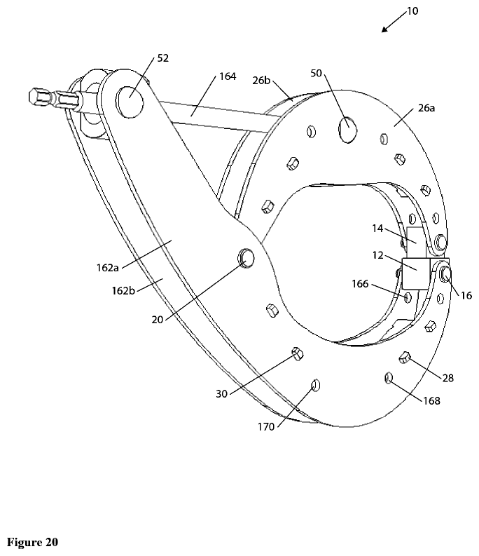

Referring now to FIG. 20 showing another configuration of clamping apparatus 10. Clamping apparatus 10 may be configured with another potential lower jaw structure 162 and threaded elongated element 164 with upper jaw structure 26 to facilitate another clamping orientation relative to the threaded elongated element 164. Potential lower jaw structures 162a, 162b may be connected with perpendicular plate elements 28, 30. Hinge 20 may be removed when desired to facilitate removing upper jaw structure 26 from lower jaw structure 162. Lower jaw structure 162 may include holes 166, 168, 170 which may facilitate the use of the potential clamp accessories designs for lower jaw structure 162.

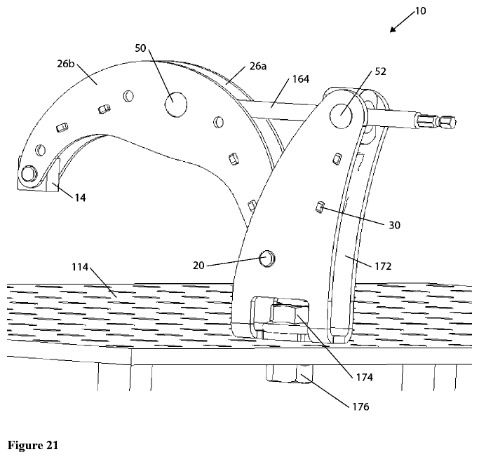

Referring now to FIG. 21 showing another configuration of clamping apparatus 10. Clamping apparatus 10 may be configured with another potential lower jaw structure 172 and use the core elongated element 164 from FIG. 21 with upper jaw structure 26 to facilitate mounting to a surface. Potential lower jaw structure 172 may connect with perpendicular plate element 30. Hinge 20 may be removed when desired to facilitate removing upper jaw structure 26 from lower jaw structure 172. Lower jaw structure 172 may connect with elongated element 174 to mount to surface 114. Lower jaw structure 172 may also be attached to a surface using welding or adhesive.

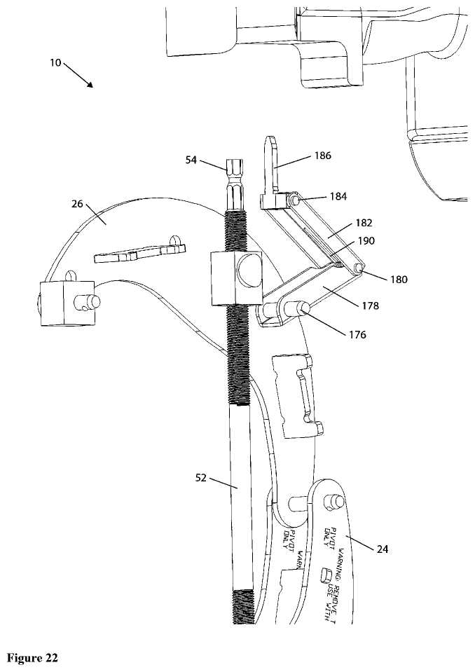

Referring now to FIGS. 22-24 showing another configuration of clamping apparatus 10. Clamping apparatus 10 may be configured with another potential clamping apparatus accessory consisting of elements which facilitates preventing the clamping apparatus 10 from rotating in relation to power tool 68. Elongated element 176 may be configured to attach elongated element 178 pivotably to upper jaw structure 26 at hole 38. Elongated element 176 may be configured to resist undesired removal but facilitate desired removal without the necessity of additional tools from upper jaw structure 26. Hinge 180 may be configured to pivotably attach elongated element 178 to elongated element 182. Elongated element 186 may be configured to be pivotably attached to elongated element 182 with hinge 184. Spring element 190 may be configured to facilitate increasing the angle between elongated element 178 and elongated element 182 to maintain retention of elongated element 186 in retention element 188. During open and closing operation of the clamp apparatus 10, the geometric relationship of the impact wrench 68 and structural jaw 26 changes. The single hand use hinge assembly is designed to accommodate these geometry changes. In addition, the single hand use hinge assembly is designed to be easily engaged with the power tool 68. This is accomplished by limiting the angular deflection at hinges 180 and 184. Power tool chuck 70 may prevent undesired removal while allowing desired removal of elongated element 54. While power tool chuck 70 is retaining elongated element 54 and while elongated elements 186 is in retention element 188 this configuration may facilitate single hand use of clamping apparatus 10 with power tool 68.

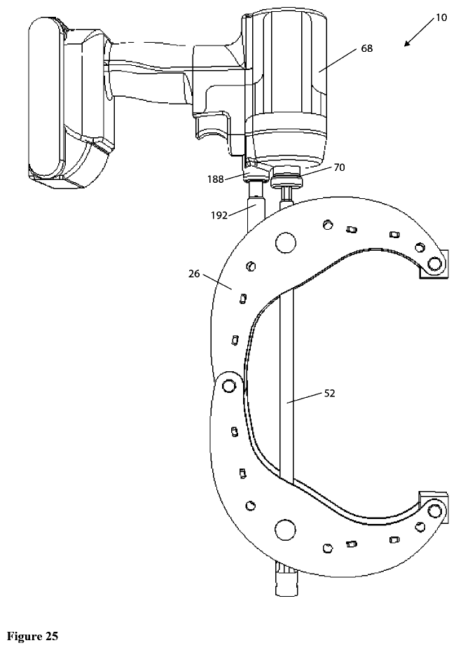

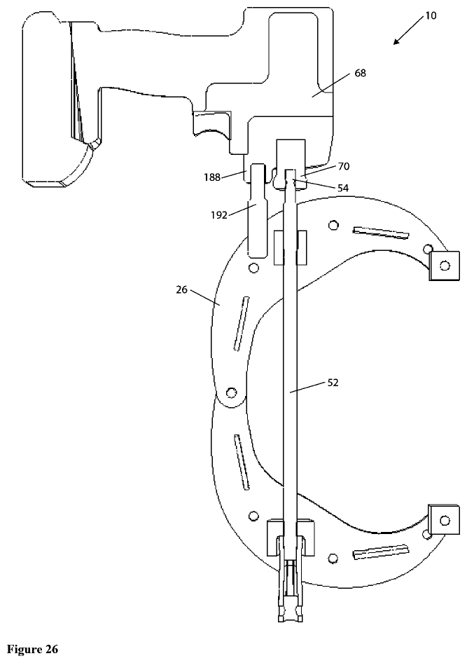

Referring now to FIGS. 25-26 showing another configuration of clamping apparatus 10. Power tool 68 may be configured with elongated element 192 which may be retained by retention element 188 to prevent undesirable removal while facilitating desired removal. Elongated element 192 may be configured to facilitate the prevention clamping apparatus 10 from rotating in relation to power tool 68 due to contact with upper jaw structure 26. Power tool chuck 70 may retain and prevent undesired removal and allow desired removal of elongated element 54. While power tool chuck 70 is retaining elongated element 54 and while elongated elements 192 is inserted into retention element 188 such that elongated element 192 may contact upper jaw structure 26 this configuration may facilitate single hand use of clamping apparatus 10 with power tool 68.

What is claimed is:

1. A clamping apparatus that is easily configured for multiple applications via the use of elongated elements that are configured to resist undesired removal but facilitate desired removal without the necessity of an additional without the necessity of an additional tool comprising:
an upper jaw structure with a hinge location, nut location, jaw location and multiple features that include but are not limited to holes that are used with elongated elements that are configured to resist undesired removal but facilitate desired removal without the necessity of an additional tool to facilitate multiple applications that include but are not limited to single hand use with a power tool, increasing the reach of the clamping apparatus jaw structures, aligning the corners of two objects at specific angles, and clamping rounded objects;
a lower jaw structure with a hinge location, nut location, clamp location and multiple features that include but are not limited to holes that are used with elongated elements that are configured to resist undesired removal but facilitate desired removal without the necessity of an additional tool to facilitate multiple applications that include but are not limited to single hand use with a power tool, increasing the reach of the clamping apparatus shoes, aligning the corners of two objects at specific angles, and clamping rounded objects;
a hinge connection between the upper and lower jaw structure consisting of an elongated element configured to resist undesired removal but facilitate desired removal without the necessity of an additional tool to facilitate interchanging jaw structures to enable different applications that include but are not limited to increasing the clearance of the jaw structure to match the needs of given scenario, and to mount the jaw structure to a surface;
an elongated element threadably engaged with the nuts of the upper and lower jaw structures, wherein rotation of the elongated element in a first direction causes the clamp ends of the first and second jaw structures to move closer together, wherein the elongated element includes an end configured with a hexagonal shape which facilitates the rotation of the elongated element via tools that include but are not limited to hand wrenches, hand ratchets, impact wrenches, impact drivers, and power drills;
a safety stop attached to an end of the elongated element which is threadably engaged with the nuts of the upper and lower jaw structures that prevents the distance between the same elongated element and the clamp hinge from getting smaller than a predetermined distance, for example to prevent pinching fingers, by bottoming on the adjacent nut; whereas the safety stop is extended below the adjacent jaw structure to provide clearance for a hole that allows an elongated element to be installed to create a handle for manual operation; whereas the handle elongated element is configured to resist undesired removal but facilitate desired removal without the necessity of an additional tool;
shoes located at the clamp end of both the upper and lower jaw structures that directly interface with the clamped object and are attached to holes in the jaw structures by elongated elements configured to resist undesired removal but facilitate desired removal without the necessity of an additional tool so that different applications can be facilitated by interchanging shoes.

2. The clamping apparatus of claim 1:
easily configured for applications that require an extended reach jaw structure enabled by elongated elements configured to resist undesired removal but facilitate desired removal without the necessity of an additional tool.

3. The clamping apparatus of claim 1:
easily configured for applications that require jaw structures shaped to permit clearance around obstacles; whereas the interchangeability of the different profile jaw structures is facilitated by the removal of the hinge connection elongated element configured to resist undesired removal but facilitate desired removal without the necessity of an additional tool.

4. The clamping apparatus of claim 1:
easily configured for but not limited to applications that require shoes that provide clearance over an object, will not leave a mark on the clamped object, will hold round objects, and can be welded; whereas the interchangeability of the shoes is facilitated by elongated elements configured to resist undesired removal but facilitate desired removal without the necessity of an additional tool inserted into holes designed into the jaw structures.

5. The clamping apparatus of claim 1:
easily configured for applications that require the transfer of electric current using specially designed shoes that retains a wire or electric contact element and an option for stress relief and/or restraint of the electrical wire/wires both attached to a jaw structure via elongated elements configured to resist undesired removal but facilitate desired removal without the necessity of an additional tool inserted into holes within the jaw structures.

6. The clamping apparatus of claim 1:
easily configured for applications that require attaching the clamp to a surface using specially designed shoes that are attached to the jaw structure via elongated elements configured to resist undesired removal but facilitate desired removal without the necessity of an additional tool inserted into holes designed into jaw structures.

7. A pair of the clamping apparatus of claim 1:
easily configured for applications that require pressure applied over a wide surface; configured clamping apparatus will comprise of:
an elongated and curved shoe shaped similar to a leaf spring with a profile designed to provide a pressure when the shoe is flattened against a planar object; and the elongated shoe bridges the space between the pair of clamping apparatus that are positioned as mirror images of each other with their shoe ends facing one another; and
the flattening force to be generated by the clamping apparatus located at each end of the elongated shoe and connected to the elongated shoe using elongated elements configured to resist undesired removal but facilitate desired removal without the necessity of an additional tool inserted into holes designed into the jaw structures.

8. A pair of the clamping apparatus of claim 1:
easily configured for applications that are assisted by the use of a heat sink pressed against an object which is often but not always planar; and the configured clamping apparatus will comprise of:
an elongated shoe made from a thermally conductive material with a flat surface for contact with the clamped object and fins opposite of the contact surface to enhance convective heat transfer to the surrounding air; and the elongated shoe bridges the space between the pair of clamping apparatus that are positioned as mirror images of each other with their shoe ends facing one another; and the clamping force to be generated by the clamping apparatus located at each end of the elongated shoe and connected to the elongated shoe using elongated elements configured to resist undesired removal but facilitate desired removal without the necessity of an additional tool inserted into holes designed into the jaw structures.

9. The clamping apparatus of claim 1:
easily configured for applications that require two orthogonal directions of clamping by attaching a structural block to the hinge end of the clamping apparatus via the hinge connection elongated element configured to resist undesired removal but facilitate desired removal without the necessity of an additional tool;
whereas this structural block threadably contains one or more elongated elements oriented perpendicular or close to perpendicular to the direction of actuation of the upper and lower shoes and that have a handle elongated element configured to resist undesired removal but facilitate desired removal without the necessity of an additional tool at their drive end and a load spreading ball socketed pad at the end that will contact the clamped object.

10. A pair of clamping apparatus of claim 1;
combined with an adjustable frame that allows two clamped objects to be oriented at a desired angle relative to one another; whereas the clamping apparatus are connected to the adjustable frame via elongated elements configured to resist undesired removal but facilitate desired removal without the necessity of an additional tool inserted into holes at the shoe end of the jaw structure; whereas the adjustable frame contains flat plates located directly adjacent to the connections to the clamping apparatus; whereas these flat plates cause the clamped objects to be oriented per the angle of the adjustable frame when clamped by the clamping apparatus.

11. The clamping apparatus of claim 1:
wherein the hexagonally shaped end of the elongated element threadably engaged with the nuts of the upper and lower jaw structures includes a circumferential groove whose geometry is an industrial standard for the retention of tools by impact drivers;
whereas in this case the clamping apparatus can be retained by the impact driver.

12. The clamping apparatus of claim 1:
easily configured for single hand use when holding an impact driver by attaching the impact driver to the clamping apparatus via the circumferentially grooved hexagonally shaped end of the elongated element which is threadably engaged with the nuts of the upper and lower jaw structures and prevention of the clamp from rotating relative to the powered impact driver when driven by the powered impact driver using a hinge mechanism configured to cope with the distance and alignment changes between the clamp and impact driver that occur when the clamp apparatus is opened and closed;
whereas the hinge anti-rotation mechanism is attached to the clamp using elongated elements configured to resist undesired removal resist undesired removal but facilitate desired removal without the necessity of an additional tool inserted into holes contained in the jaw structure closest to the impact driver;
whereas the hinge anti-rotation mechanism is attached to the impact driver with an elongated element which is part of the hinge anti-rotation mechanism that engages with a socket or other feature contained within the impact driver;
whereas the hinge anti-rotation mechanism contains a spring element that is configured to attempt to open the hinge fully and thus pushes the elongated element into the impact driver engagement feature thereby ensuring the anti-rotation connection regardless of the open or closed position of the clamp apparatus.

13. The clamping apparatus of claim 1:
easily configured for single hand use when holding a impact driver by attaching the impact driver to the clamping apparatus via the circumferentially grooved hexagonally shaped end of the elongated element which is threadably engaged with the nuts of the upper and lower jaw structures and prevention of the clamping apparatus from rotating relative to the powered impact driver when driven by the powered impact driver using an elongated element attached to the impact driver that extends between two parallel plates in the adjacent jaw structure and/or into a slot built into the clamping apparatus jaw structure closest to the impact driver; whereas the slotted engagement allows the pin engagement to cope with the distance and alignment changes between the clamping apparatus and impact driver that occur when the clamping apparatus is opened and closed.

14. A clamp shoe configured for use with a clamping apparatus that is designed to facilitate the clamping of a wide diameter range of round objects; whereas the wide diameter range of clamped objects is facilitated by the double clamp end design; whereas one end of the clamp jaw has a v-shaped notch with a depth that is sized for clamping objects smaller in diameter; and the other end has a v-shaped notch with a depth that is sized for clamping objects larger in diameter; whereas the orientation of the v-shaped notches are optimized to best maintain a normal orientation of the v-shaped notch angle bisecting vector to the opposite clamp shoe;
and the clamp shoe is easily reversed as a result of its attachment configuration to the clamping apparatus; whereas this attachment configuration uses two or more elongated elements that are configured to resist undesired removal but permit desired removal without the necessity of an additional tool; such that the clamp shoe will not rotate.

15. A clamp attachment that is configured to facilitate extending the reach of a clamping apparatus; whereas the extended reach attachment is constructed of plates that are tab/slotted/riveted together, shaped for maximum functionality and sized to withstand the loads created by the clamp; and. the extended reach attachment is easily attached to the clamping apparatus using elongated elements that are configured to resist undesired removal but permit desired removal without the necessity of an additional tool; whereas the extended reach attachment is configured to facilitate using the full range of clamp shoes available to the clamping apparatus.

16. This claim applies to the hexagonally shaped end with circumferential groove in the threaded element in any mechanical clamp that is configured to facilitate being driven by the female hex drive that is integral and standardized to impact drivers.

17. This claim applies to the circumferential groove in the hex of the threaded element in any mechanical clamp that is configured to facilitate being driven by the female hex drive that is integral and standardized to impact drivers.

18. This claim applies to a clamping apparatus anti-rotation hinge device which has been configured to facilitate single-handed impact driver clamp operation; whereas a hinge device consisting of an end attached to the clamp in a manner that allows some degree of rotation, a hinge in the middle that is spring loaded to desire further opening and finally an elongated element attached to the impact wrench end of the hinge device in a manner that allows some degree of rotation that will engage with the impact driver; and the spring loaded middle hinge applies a steady load that ensures the elongated element stays engaged with the impact driver; and the opening and closing of the hinge will accommodate the clamp distance and position changes relative to the impact driver during opening and closing while preventing the clamp from rotating relative to the impact driver;
whereas all three of the joints of the hinge are configured with limited rotation; and this limitation does not impact the operation of the hinge but does make the hinge easy to engage with the impact wrench when installing the clamp.

19. This claim applies to a clamping apparatus anti-rotation elongated element which has been configured to facilitate single-handed impact driver clamp operation;
whereas an elongated element attached to the impact driver engages a slotted feature in the clamp; and the slotted geometry will accommodate the clamp distance and position changes relative to the impact wrench during opening and closing while preventing the clamp from rotating relative to the impact wrench.

20. A clamping apparatus that is easily configured for multiple applications via the use of elongated elements that are configured to resist undesired removal but permit desired removal without the necessity of an additional tool comprising:
an upper jaw structure with a hinge end, clamp end, nut location between the ends and multiple features that include but are not limited to holes that are used with elongated elements that are configured to resist undesired removal but permit desired removal without the necessity of an additional tool to facilitate multiple applications that include but are not limited to single hand use with a power tool, increasing the reach of the clamping apparatus shoes, aligning the corners of two objects at specific angles, and clamping rounded objects;
a lower jaw structure with a nut end, clamp end, hinge location between the ends and multiple features that include but are not limited to holes that are used with elongated elements that are configured to resist undesired removal but permit desired removal without the necessity of an additional tool to facilitate multiple applications that include but are not limited to single hand use with a power tool, increasing the reach of the clamping apparatus shoes, aligning the corners of two objects at specific angles, and clamping rounded objects;
a hinge connection between upper and lower jaw structure consisting of an elongated element configured to resist undesired removal resist but facilitate desired removal without the necessity of an additional tool to facilitate interchanging jaw structures to enable different applications that include but are not limited to increasing the clearance of the jaw structure to match the needs of given scenario;
an elongated element threadably engaged with the nuts of the upper and lower jaw structures, wherein rotation of the elongated element in a first direction causes the clamp ends of the jaw structures to move closer together, wherein the elongated element includes an end configured with a hexagonal shape to facilitate the rotation of the elongated element via tools that include but are not limited to hand wrenches, hand ratchets and impact drivers, impact wrenches wrench, and drills;
shoes located at the clamp end of both the upper and lower jaw structures that directly interface with the clamped object and are attached to holes in the jaw structures by elongated elements configured to resist undesired removal but facilitate desired removal without the necessity of an additional tool so that different applications can be facilitated by interchanging shoes.

21. A clamping apparatus that is easily configured for multiple applications via the use of elongated elements that are configured to resist undesired removal but permit desired removal without the necessity of an additional tool comprising:
a jaw structure with a hinge end, clamp end, nut location between the ends and multiple features that include but are not limited to holes that are used with elongated elements that are configured to resist undesired removal but permit desired removal without the necessity of an additional to facilitate multiple applications that include but are not limited to the low profile jaw structure and extended reach jaw structure;
a mount structure with a nut end and mount end, a hinge location between the ends and features that include but are not limited to holes that are used with elongated elements that are configured to resist undesired removal but permit desired removal without the necessity of an additional tool to facilitate multiple applications that include but are not limited to increasing the reach of the clamping apparatus, and single hand or remote operation using an impact driver or other power tool;
a hinge connection between the jaw structure and mount structure consisting of an elongated element configured to resist undesired removal but facilitate desired removal without the necessity of an additional tool to facilitate interchanging jaw structures to enable different applications that include but are not limited to deep and low profile jaw structures;
an elongated element threadably engaged with the nuts of the jaw structure and mount structure, wherein rotation of the elongated element in a upper direction causes the clamp ends of the jaw structures to move closer together, wherein the elongated element includes an end configured with a hexagonal shape to facilitate the rotation of the elongated element via tools that include but are not limited to hand wrenches, hand ratchets, impact wrenches, impact drivers, and drills;
shoes located at the clamp end of the jaw structure that directly interface with the clamped object and are attached to holes in the jaw structure by elongated elements configured to resist undesired removal but facilitate desired removal without the necessity of an additional tool so that different applications can be facilitated by interchanging shoes.
